(19) United States
(12) Patent Application Publication
(10) Pub. No.: US 2013/0162411 A1
(43) Pub. Date: Jun. 27, 2013

(54) METHOD AND APPARATUS TO ADAPT A REMOTE CONTROL USER INTERFACE

(71) Applicants: Daniel Moses, San Diego, CA (US); Kalin M. Atanassov, San Diego, CA (US); Sergiu R. Goma, San Diego, CA (US); Milivoje Aleksic, San Diego, CA (US)

(72) Inventors: Daniel Moses, San Diego, CA (US); Kalin M. Atanassov, San Diego, CA (US); Sergiu R. Goma, San Diego, CA (US); Milivoje Aleksic, San Diego, CA (US)

(73) Assignee: QUALCOMM Incorporated, San Diego, CA (US)

(21) Appl. No.: 13/334,625

(22) Filed: Dec. 22, 2011

(51) Int. Cl. G08C 19/16

(52) U.S. Cl. 340/12.5; 340/12.54

(57) ABSTRACT

Described herein are methods, apparatus, and computer readable media to control a user interface on a remote control. A first device command may be received from a remote control. This device command may cause the device to leave a first functional mode and enter a second functional mode. A first remote control command may then be sent to the remote control, with the first remote control command identifying a first remote control user interface to be displayed. The user interface may be operative to control features of the device unique to the second functional mode.

### TECHNICAL FIELD

The present embodiments relate to multi-media devices, and in particular, methods and apparatus for adapting the content of a remote control for a multimedia device.

### BACKGROUND

Multimedia servers may provide access to a wide range of multimedia content available both locally on the server and also over the Internet. Depending on the type of content being accessed by the multimedia server, the functions available for the server to perform may vary. For example, when accessing audio content, a player user interface that includes play, rewind, fast forward, skip, next track may be appropriate. When browsing the Internet or searching for media files, a full function keyboard may be appropriate. Similarly, when presenting a photo album or photo viewing experience, other user interface controls may be appropriate.

User interfaces for multimedia servers may take many forms. For example, some multimedia servers may be comprised of multiple components. Each component may include an interface appropriate for the functionality it provides, similar to a traditional component audio system. As the individual components of a multimedia system have become more closely integrated, integration of their user interfaces has also occurred. For example, some multimedia servers provide user interfaces on a typical personal computer display. These displays are of a size that allows display of the many disparate controls that may be used to control all the capabilities available via a multimedia server. However, these traditional display interfaces are not portable and do not provide the convenience demanded by today's modern consumer.

Remote controls have also been provided for multimedia servers. These provide the portability and convenience today's consumer expects in their multimedia devices. Existing remote control solutions use a variety of methods to accommodate the disparate features and capabilities of a modern multimedia server in the smaller form factor of a portable remote control. Some remote controls provide for a larger size that can accommodate buttons and other controls for each type of multimedia content used by the devices controlled by the remote. The size of these remote controls may make them less portable. Furthermore, the large number of buttons and controls present on the remote control may also make them appear more complex and more difficult to understand. When operating such a remote control, a user must be able to associate the active function of the multimedia server with a particular area or section of the remote control to which that active function corresponds. Once this association is made, the user may be able to identify which controls should be used to accomplish their task. For less sophisticated users, this may present a challenge to their user experience and result in generally less overall satisfaction.

Other solutions may provide a remote control with a smaller form factor, and rely on multi-purposing some or all of the buttons and controls. The buttons or controls may provide different functions depending on the functional mode of the multimedia server being controlled. These remote controls may include labels for each control that communicate its multiple functions via different colors, fonts, or the like. For example, a remote may use a button that represents a “2” in one functional mode. In another functional mode, the same button may represent a letter, for example, “A”, “B”, or “C.” In some implementations, the number of presses within a certain time period may further define use of the button. For example, one press may represent an “A”, while two presses may represent a “B.”

While this solution provides the smaller form factor in a remote control having the power to control the disparate functions provided by a modern Internet media server, providing buttons and other controls with multiple uses depending on the functional mode of the multimedia server can be confusing for some users. This solution may limit the usability of the multimedia server and correspondingly customer satisfaction. Since many multimedia servers provide for post-sale revenue opportunities, for example by media subscriptions and pay per use offerings, reduced usability may translate into reduced revenue for the multimedia server manufacturer.

### SUMMARY

The systems, methods and devices of the disclosure each have several innovative aspects, no single one of which is solely responsible for the desirable attributes disclosed herein.

One innovative aspect disclosed includes a method of displaying a user interface on a remote control. This method may include sending a first command to a multifunction device. The first command may result in the device leaving a first functional mode and entering a second functional mode. The method may further include receiving a second command from the multifunction device, with the second command identifying a first remote control user interface to be displayed, with the first remote control user interface operative to control features of the multifunction device unique to the second functional mode. The method may also include displaying the first remote control user interface on an electronic display. Some of these implementations also include sending a third command to the multifunction device in response to an input from the first remote control user interface. In some of these implementations, data enabling the display of the first remote control user interface is stored in a memory of the remote control before the second command identifying the first remote control user interface is received by the remote control. In some of these implementations, the input is a touch gesture. In some implementations, the first remote control user interface comprises a virtual keyboard. In some other implementations, the first remote control user interface allows gesture input.

Another innovative aspect disclosed is a remote control apparatus. The apparatus may include an electronic display, a device command sending module configured to send a first command to a multifunction device, with the first command resulting in the multifunction device entering a first functional mode. The apparatus may also include a remote command receiving module, configured to receive a second command from the multifunction device, with the second command identifying a first remote control user interface to be displayed, the first remote control user interface operative to control features of the device unique to the first functional mode, and a display module, configured to display the first remote control user interface on the electronic display. In some implementations, the command sending module is configured to send the first command by using a radio transmitter, a Bluetooth compatible transmitter, or an infrared compatible transmitter.

In some implementations, the remote control apparatus is configured to store a plurality of user interfaces that can be displayed on the display screen. In some other implementations, the electronic display is a touch-screen display. In some implementations, the apparatus is a wireless telephone. In some implementations, the second command identifies the first remote control user interface by specifying an identifier stored in a memory of the remote control apparatus.

Another innovative aspect disclosed includes a remote control apparatus. The apparatus includes means for sending a first command to a multifunction device, wherein the first command results in the device leaving a first functional mode and entering a second functional mode, means for receiving a second command from the multifunction device, wherein the second command identifies a first remote control user interface to be displayed, the first remote control user interface operative to control features of the multifunction device unique to the second functional mode, and means for displaying the first remote control user interface on an electronic display.

In some implementations of the remote control apparatus the means for sending a first command to the multifunction device is processor instructions in a device command sending module. In some other implementations, the means for receiving a second command from the multifunction device is processor instructions in a remote command receiving module. In some implementations, the means for sending a first command to a multifunction device sends the first command by using a radio transmitter, a Bluetooth compatible transmitter, or an infrared compatible transmitter. In some implementations, the remote control apparatus also includes a means for storing a plurality of user interfaces that can be displayed by the means for displaying.

In some implementations, the means for displaying a first remote control user interface includes a touch-screen display. In some implementations, the apparatus is a wireless telephone. In some implementations, the second command identifies the first remote control user interface by specifying an identifier stored in a memory of the remote control apparatus.

Another innovative aspect disclosed is a non-transitory, computer readable storage medium having instructions stored thereon that cause a processing circuit to perform a method. The method may include sending a first command to a multifunction device. The first command may result in the device leaving a first functional mode and entering a second functional mode. The method may also include receiving a second command from the multifunction device, with the second command identifying a first remote control user interface to be displayed, the first remote control user interface operative to control features of the multifunction device unique to the second functional mode, and displaying the first remote control user interface on an electronic display. Some of these computer readable storage mediums the method also includes sending a third command to the multifunction device in response to an input from the first remote control user interface. In some implementations, data enabling the display of the first remote control user interface is stored in a memory of the remote control before the second command identifying the first remote control user interface is received by the remote control.

In some implementations, an input is a touch gesture. In some other implementations, the first remote control user interface comprises a virtual keyboard. In some implementations, the first remote control user interface allows gesture input.

Another innovative aspect of the subject matter described in this disclosure can be implemented in a multifunction device as a method for controlling a user interface on a remote control. The method may include receiving a first device command from the remote control. The first device command may result in the device leaving a first functional mode and entering a second functional mode. The method may further include sending a first remote control command to the remote control. In some implementations, the first remote control command identifies a first remote control user interface to be displayed, and the first remote control user interface is operative to control features of the device unique to the second functional mode.

In some implementations, the first remote control command identifies a first remote control user interface by including an identifier corresponding to the first remote control user interface. In some other implementations the method may also include receiving a second device command from the remote control. In these implementations, the second device command results in the device leaving the second functional mode and entering a third functional mode. The method may also include sending a second remote control command to the remote control, and the second remote control command may identify a second remote control user interface to be displayed, with the second remote control user interface operative to control features of the device unique to the third functional mode. In some implementations, the first remote control command is sent over a Bluetooth connection or a WIFI network. In some other implementations, the first remote control command is sent over the Internet.

Another innovative aspect is a multifunction device including a device command receiving module, configured to receive a first device command from a remote control, wherein the first device command results in the device leaving a first functional mode and entering a second functional mode, and a remote command sending module, configured to send a first remote control command to the remote control, wherein the first remote control command identifies a first remote control user interface to be displayed, the first remote control user interface operative to control features of the device unique to the second functional mode.

In some implementations, the first remote control command identifies a first remote control user interface by including an identifier corresponding to the first remote control user interface. In some implementations of the multifunction device, the device command receiving module is further configured to receive a second device command from the remote control, wherein the second device command results in the device leaving the second functional mode and entering a third functional mode, and the remote command sending module is further configured to send a second remote control command to the remote control, wherein the second remote control command identifies a second remote control user interface to be displayed, the second remote control user interface operative to control features of the device unique to the third functional mode.

Another innovative aspect is a multifunction device, including a means for receiving a first device command from a remote control, wherein the first device command results in the device leaving a first functional mode and entering a second functional mode, and a means for sending a first remote control command to the remote control, wherein the first remote control command identifies a first remote control user interface to be displayed, the first remote control user interface operative to control features of the device unique to the second functional mode.

In some implementations, the means for receiving a first device command is processor instructions in a device command receiving module. In some implementations, the means for sending a first remote control command is processor instructions in a remote command sending module. The first remote control command may identify a first remote control user interface by including an identifier corresponding to the first remote control user interface.

In some implementations, the multifunction device also includes means for receiving a second device command from the remote control, wherein the second device command results in the device leaving the second functional mode and entering a third functional mode, and means for sending a second remote control command to the remote control, wherein the second remote control command identifies a second remote control user interface to be displayed, the second remote control user interface operative to control features of the device unique to the third functional mode.

Another innovative aspect disclosed is a non-transitory, computer readable storage medium having instructions stored thereon that cause a processing circuit to perform a method. The method may include receiving a first device command from a remote control, with the first device command resulting in the device leaving a first functional mode and entering a second functional mode. The media may also include instructions that cause the processing circuit to send a first remote control command to the remote control, with the first remote control command identifying a first remote control user interface to be displayed, the first remote control user interface operative to control features of the device unique to the second functional mode.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 shows an overview of a multimedia environment including an Internet media server device and a content adaptive remote.

FIG. 2 shows a conceptual diagram of four possible user interfaces displayed on a content adaptive remote while the remote controls an Internet multimedia server device.

FIG. 3 shows a block diagram of an exemplary implementation of a content adaptive remote.

FIG. 4 shows a block diagram of an exemplary implementation of an Internet multimedia server device.

FIG. 5 shows a flowchart that may run within one implementation of an Internet multimedia server device. FIG. 5 also shows a flowchart that may run within one implementation of a content adaptive remote.

FIG. 6 shows a flowchart of a process that may run within one implementation of an Internet multimedia server device.

FIG. 7 shows a flowchart of a process that may run within one implementation of a content adaptive remote.

### DETAILED DESCRIPTION

Implementations disclosed herein relate to a method and apparatus for adapting the user interface of a remote control to the functional mode of an Internet multimedia server. One embodiment relates to a system or method for providing a multifunctional remote control that changes its user interface during operation of different multimedia devices. For example, the remote control may have a first user interface when operating a music function on a multimedia server, and then change into a second user interface when operating a video on the multimedia server. In one embodiment, the multimedia server wirelessly communicates to the remote control an appropriate interface to display to the user depending on the mode that is operating on the multimedia server. In one embodiment, the system identifies a user interface on a remote control from a multifunction device. For example, the multifunction device such as a multimedia server may receive a command from the remote control, where the command results in the multimedia device entering a first functional mode. The multimedia device may then send a remote control command to the remote control. The remote control command may identify a first remote control user interface to be displayed on the remote control, with the first remote control user interface operative to control features of the device unique to the first functional mode. One skilled in the art will recognize that these embodiments may be implemented in hardware, software, firmware, or any combination thereof.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As described earlier, existing remote control solutions for an Internet multimedia server have some shortcomings. Large remote controls that provide adequate space available for the multiple controls needed for the disparate functions of modern Internet multimedia servers are less portable, and the large number of controls may confuse users and reduce usability. Smaller, more portable remote control designs that overload buttons with multiple functions meet users form factor requirements but still suffer from ease of use challenges.

The disclosed methods and apparatus solve these shortcomings by providing a remote control with an adaptive user interface. Embodiments of the remote control described herein may utilize a touch screen display that meets the form factor expectations of modern consumers. On that touch screen display can be provided multiple user interfaces, one or more or those user interfaces adapted to provide control of each functional mode of an Internet multimedia server device. By providing at least one user interface for each functional mode of the Internet multimedia server device, the interface(s) may be specialized to tailor the user experience for the tasks associated with the functional mode. This specialization may include an ability to express a set of user interface controls specifically tailored for the functional mode. For example, in some functional modes, some buttons or controls may be included while other buttons are not present on the remote control user interface.

Some user interfaces may include only a very small number of controls, so as to provide improved usability. For example, a functional mode that provides playback of audio files may have a relatively simplified user interface, including controls for the traditional, play, fast forward, skip, and other well known functions. Another functional mode that provides Internet browsing or searching may present a soft keyboard interface, enabling the user to type on their remote control similar to how they may type on a mobile phone or a tablet computer.

The sizes of controls may also vary across functional modes. For example, a remote user interface designed for gaming applications may include larger buttons than some other functional modes. The larger buttons may be more easily activated during fast paced game play and reduce the need for the user to look at the remote control. The ability for the remote control to express a variety of colors when the Internet multimedia server is in a gaming functional mode may also be desirable, as colors may provide a more appealing user interface for children.

How the remote provides feedback to a user may also vary across functional modes. For example, some remote control user interfaces may play a sound when controls are activated. In other interfaces, a control's color may change or it may become larger when activated. In other user interfaces, for example, a gaming user interface, the gaming remote may shake or buzz, depending on the current state of the game being played.

When the Internet media server is powered on and connects with the remote control, it may send a command to the remote control. The command may identify a first user interface, via a specific well known identifier or other method, to the remote control. Since the Internet media server may have just completed a power on event, the first user interface may be a home screen, for example, a screen that allows selection of any number of functional modes supported by the Internet media server. Upon receiving the identifier, the remote control may retrieve data from its non volatile storage based on the identifier. The data may define the layout, graphic scheme, and controls for the first user interface identified by the Internet media server. The remote control may then provide this data to a display module of the remote control to display the first user interface on its touch screen display.

After the first user interface is displayed, the user may then enter a command via the displayed user interface. If the first user interface is a home screen, a command may be entered that transitions the Internet multimedia server device to another functional mode. This command may then be sent by the remote control to the Internet media server. When the Internet media server device receives this command, the Internet media server device may transition into a second functional mode.

In response, the Internet media server device may send a second command to the remote control, identifying a second user interface to be displayed. When the remote control receives this command, it may again retrieve data from its non volatile storage based on the identifier in the command sent by the Internet media server device. The data retrieved may define the user interface to be displayed that corresponds to the second functional mode of the Internet media server. The remote control may then display this user interface.

Each user interface presented by the remote control may be either stored within the remote control, or may be transferred to the remote control by the Internet multimedia server. In one implementation, the remote control includes a non volatile storage such as a flash, hard disk, or SDRAM that includes data defining the user interfaces to be provided for each functional mode of the Internet media server. When the Internet multimedia server enters a new functional mode and sends a command to the content adaptive remote, the Internet multimedia server may provide an identifier or index to the content adaptive remote control. Upon receiving the identifier, the content adaptive remote may read data defining the layout, controls, and graphical elements of the identified user interface from its non volatile storage. The data may be read based on the identifier. This data may then be used to display the user interface on the content adaptive remote's touch screen display.

The data defining the user interfaces displayable by the content adaptive remote control may be updatable. For example, the content adaptive remote may include an external connector or I/O port. This port may be a USB connection in some implementations. By connecting the content adaptive remote to an update facility over the USB connection, new user interfaces may be downloaded to the content adaptive remote. If new Internet multimedia server devices are developed, it may be possible to update the content adaptive remote control so that it can display user interfaces for these new devices.

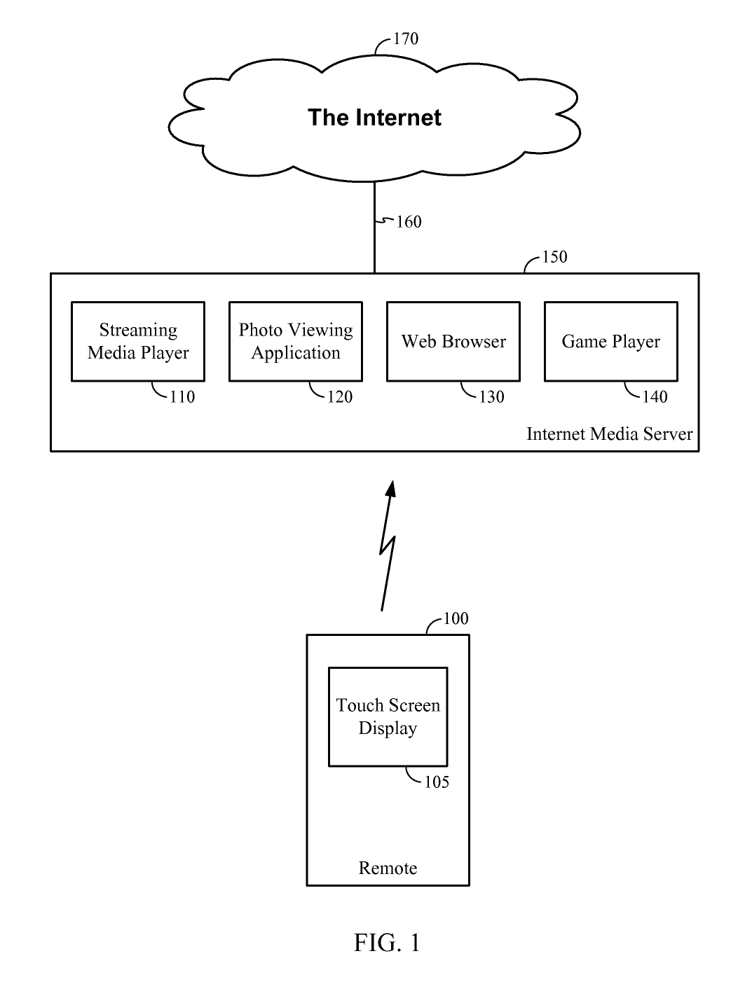

FIG. 1 shows an overview of an exemplary Internet multimedia environment. Internet multimedia server 150 connects to the Internet 170 via link 160 to provide its multimedia functions. In some implementations, link 160 may be a broadband link such as a cable model or digital subscriber line (DSL) connection. Internet media server 150 may include multiple functional modes. For example, a streaming functional mode may correspond to streaming media player 110, a web browsing functional mode may correspond to web browser 120, a photo viewing functional mode may correspond to photo viewing application 130, and a gaming functional mode may correspond to game player 140. Internet media server 150 may be controlled by remote control 100. Remote control 100 includes a touch screen display 105 for displaying user interfaces corresponding to functional modes of Internet media server 150. Touch screen display 105 may also accept input from a user corresponding to commands for Internet media server 150.

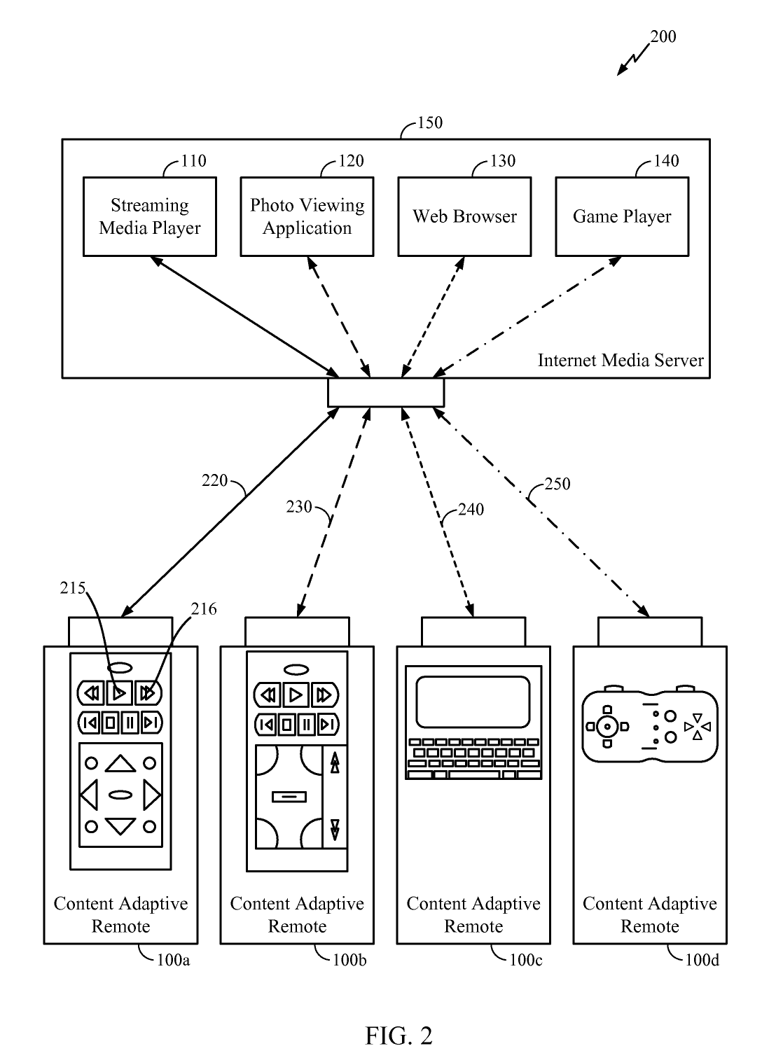

FIG. 2 shows a diagram of four possible user interfaces displayed on a content adaptive remote while the remote controls an Internet multimedia server device. Internet multimedia server 150 includes streaming media player 110, photo viewing application 120, web browser 130, and game player 140. A content adaptive remote, such as content adaptive remote 100 illustrated in FIG. 1, communicates bidirectionally with Internet media server over communication flows 220, 230, 240, and 250. Content adaptive remote 100 may adapt its user interface to correspond to the different functional modes of Internet media server 150. Example versions of a content adaptive remote are illustrated as content adaptive remotes 100a-d. Content adaptive remote 100 may adapt to a functional mode of the Internet media server device 150 that utilizes the streaming media player 110 by displaying the user interface illustrated by content adaptive remote version 100a. The user interface of content adaptive remote 100a may be adapted for the specific functions of an Internet streaming player. For example, play button 215 and fast forward button 216 are illustrated. When the Internet media server is in the streaming player functional mode, content adaptive remote 100a communicates with the streaming media player over communication flow 220, shown by the solid bidirectional arrow between content adaptive remote 100a and streaming media player 110.

Similarly, when Internet media server device 150 is in the photo viewer functional mode, content adaptive remote 100 expresses the user interface illustrated by content adaptive remote version 100b. The user interface of content adaptive remote 100b may communicate with a photo viewing application 120 over the dashed bidirectional flow illustrated as item 230.

When the web browser 130 functional mode is active, the user interface illustrated by content adaptive remote 100c may be expressed. The user interface of content adaptive remote 100c may communicate with the web browser application of the Internet media server 150 over communication flow 240, shown with the finely dashed bidirectional arrow.

When the gaming functional mode is active, the user interface illustrated by content adaptive remote 100d may be expressed. The user interface of content adaptive remote 100d may communicate with the game player 140 application of the Internet media server 150 over communication flow 250, shown with the combined dash and dotted bidirectional arrow.

Therefore, content adaptive remote 100 may express multiple user interfaces, shown as content adaptive remotes 100a-d, in order to provide remote control functions for the functional modes of Internet multimedia server device 150 corresponding to the use of streaming media player 110, photo viewing application 120, web browsing application 130, and gaming application 140.

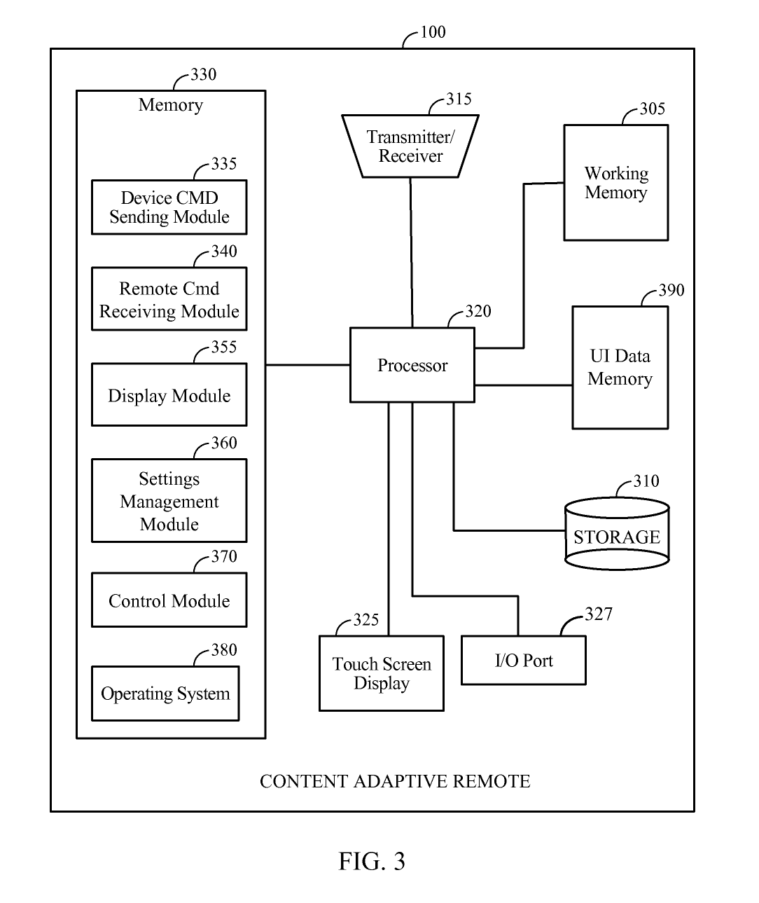

FIG. 3 shows a block diagram of an exemplary implementation of a content adaptive remote 100. Content adaptive remote 100 may be a dedicated remote control, a mobile phone, personal digital assistant, tablet computer, or the like. Device 100 may also be a more stationary device such as a desktop personal computer, or the like.

Device 100 includes a processor 320. Connected to processor 320 are a transmitter/receiver module 315, working memory 305, UI data memory 390, and non volatile storage 310. Also connected to processor 320 are a touch screen display 325, and a memory 330. Memory 330 stores several modules that include instructions for processor 320. These instructions configure processor 320 to perform various remote control tasks. Memory 330 includes a device command sending module 335, remote command receiving module 340, display module 355, settings management module 360, control module 370 and operating system 380.

Working memory 305 may be used by processor 320 to store a working set of processor instructions contained in the modules of memory 330. Alternatively, working memory 305 may also be used by processor 320 to store dynamic data created during the operation of device 100.

As mentioned above, the processor is configured by several modules stored in the memories. The device command sending module 335 includes instructions that configure processor 320 to send commands via transmitter/receiver module 315 to an Internet media server device. The remote command receiving module 340 includes instructions that configure the processor 320 to receive commands from an Internet media server device over transmitter/receiver module 315. Display module 335 includes instructions that configure processor 320 to display a user interface on touch screen display 325. Instructions in display module 355 may also configure processor 320 to receive input via touch screen display 325. In some implementations, display module 355 may configure processor 320 to retrieve data from UI data memory 390. Memory stored in UI data memory 390 may define the layout, controls, and graphical resources for a user interface to be displayed on touch screen display 325. By processing the data stored in UI data memory 390, display module 355 may render a user interface on touch screen display 325.

Settings management module 360 includes instructions that configure processor 320 to store and read global settings for remote control 100. For example, settings management module 360 may configure processor 320 to store settings associated with the type of Internet media server device remote control 100 will be controlling. This information may be used, for example, when sending commands and displaying user interfaces on touch screen display 325.

Control module 370 may include instructions that configure processor 320 to control the overall operation of remote control 100. For example, control module 370 may cause processor 320 to receive a command from an Internet media server device by calling subroutines or functions in remote command receiving module 340. Once the command is received, control module 370 may identify UI data stored in UI data memory 390 based on an identifier included in the command received by remote command receiving module 340. Control module 370 may then pass this data to display module 355, by calling a subroutine in display module 355, such that instructions in display module 355 configure processor 320 to display a user interface on touch screen display 325. Control module 370 may then detect a touch input on touch screen display 325, in some implementations via instructions included in display module 355. The touch input may identify a command for an Internet media server device. Control module 370 may then send the command to an Internet media server device via instructions in device command sending module 335. The command may be sent via transmitter/receiver 315.

Although FIG. 3 depicts a device 100 comprising separate components to include a processor and memory, one skilled in the art would recognize that these separate components may be combined in a variety of ways to achieve particular design objectives. For example, in an alternative embodiment, the memory components may be combined with processor components to save cost and improve performance.

Additionally, although FIG. 3 illustrates two memory components, to include memory component 330 comprising several modules, and a separate memory 305 comprising a working memory, one with skill in the art would recognize several embodiments utilizing different memory architectures. For example, a design may utilize ROM or static RAM memory for the storage of processor instructions implementing the modules contained in memory 330. Alternatively, processor instructions may be read at system startup from a disk storage device that is integrated into device 100. The processor instructions may then be loaded into RAM to facilitate execution by the processor. For example, working memory 305 may be a RAM memory, with instructions loaded into working memory 305 before execution by the processor 320.

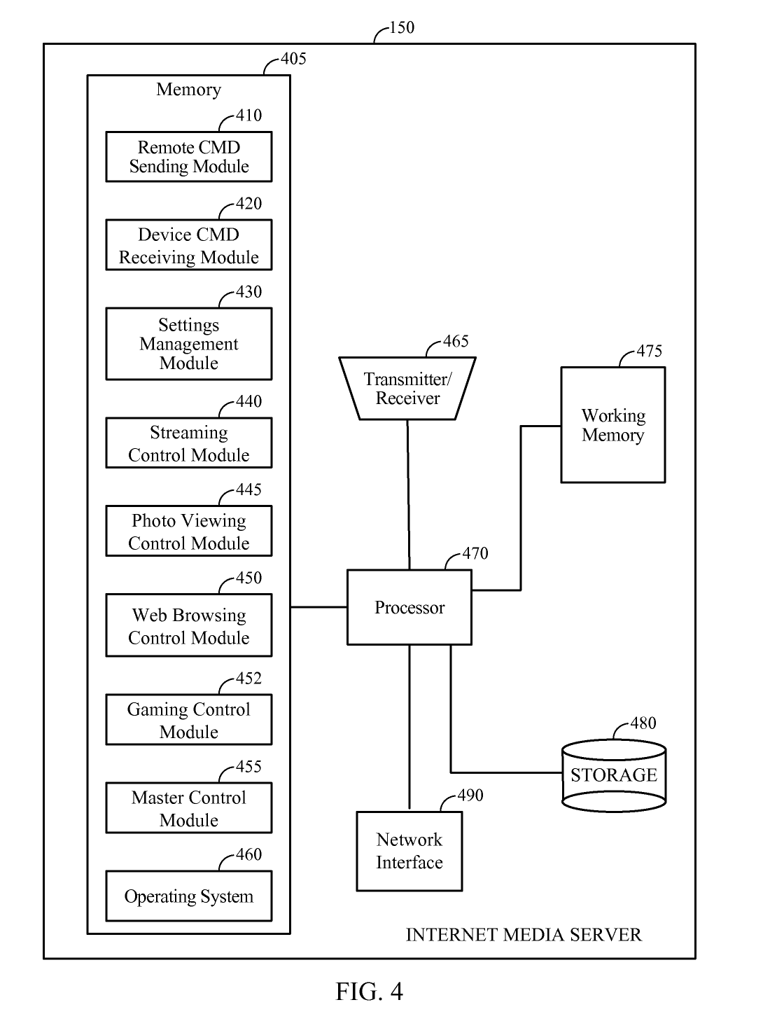

FIG. 4 shows a block diagram of one example implementation of an Internet media server device. Shown in the center is a processor 470. Processor 470 is connected to a transmitter/receiver module 465, a memory 405, a working memory 475, a storage 480, and a network interface 490. Transmitter/receiver module 465 may be used in some implementations to communicate with a content adaptive remote 100, as illustrated in FIG. 3. Network Interface 490 may be used for Internet media server device 150 to communicate over the Internet to any number of multimedia data sources. Storage 480 may be a hard disk, static ram, or other stable storage. Internet media server 150 may use working memory 475 to store dynamic data read and written during the operation. For example, working memory 475 may include swap space or store the working set for instructions executed by processor 470. Memory 405 stores a number of modules containing instructions executed by processor 470. Remote command sending module 410 may include instructions that configure processor 470 to send commands to a content adaptive remote control, such as remote 100 illustrated in FIG. 1 and FIG. 3. Device command receiving module 420 may include instructions that configure processor 470 to receive Internet media server command from a content adaptive remote. Settings management module 430 may include instructions that configure processor 470 to store and retrieve settings used for operation of Internet media server device 150. For example, settings management module 430 may store and retrieve settings from storage 480. Settings may include for example, customized parameters for the operation of Internet media server 150. Streaming control module 440 includes instructions that configure the processor to implement the streaming functions of Internet media server 150. For example, streaming control module 440 may include instructions that receive data streams from servers located on the Internet. Those streams may be received using network interface 490. Streaming control module 440 may also send commands to a content adaptive remote control via remote command sending module 410. Streaming control module 440 may also receive commands from a content adaptive remote control via device command receiving module 420.

Photo viewing control module 445 may include instructions that configure processor 470 to implement the photo viewing functions of Internet media server 150. Photo viewing control module 445 may read photos from servers located on the Internet, and connect and transfer data between those servers and Internet media server 150 over network interface 490. Photo viewing control module 445 may also send commands to a content adaptive remote control via remote command sending module 410. Photo viewing control module 445 may also receive commands from a content adaptive remote via instructions in device command receiving module 420.

Similarly, web browsing control module 450 may include instructions that configure processor 470 to implement the web browsing functions of Internet media server 150. Web Browsing control module may send commands to a content adaptive remote by invoking subroutines in remote command sending module 410 and may receive commands from a content adaptive remote via device command receiving module 420.

Gaming control module 452 may include instructions that configure processor 470 to implement the gaming functions of Internet media server 150. Gaming control module may send commands to a content adaptive remote by invoking subroutines in remote command sending module 410 and may receive commands from a content adaptive remote via device command receiving module 420.

Master control module 455 may include instructions to control the overall operation of Internet media server 150. For example, master control module 455 may include instructions that invoke streaming control module 440, photo viewing control module 445, or web browsing control module 450 depending on the functional mode commanded by a user. Master control module may also receive commands via device command receiving module 420.

Operating system module 460 may include instructions that manage the hardware and software resources of Internet media server 150. For example, operating system module 460 may include device drivers that control network interface 490 and transmitter/receiver 465. Operating system 460 may also include memory management functions that control the swap space or working set of working memory 475. Operating system module 460 may include operating systems such as Linux, VxWorks, Unix, or other well known device operating systems known in the art. Operating system 460 may also be a custom developed operating system specialized for the environment of Internet media server device 150.

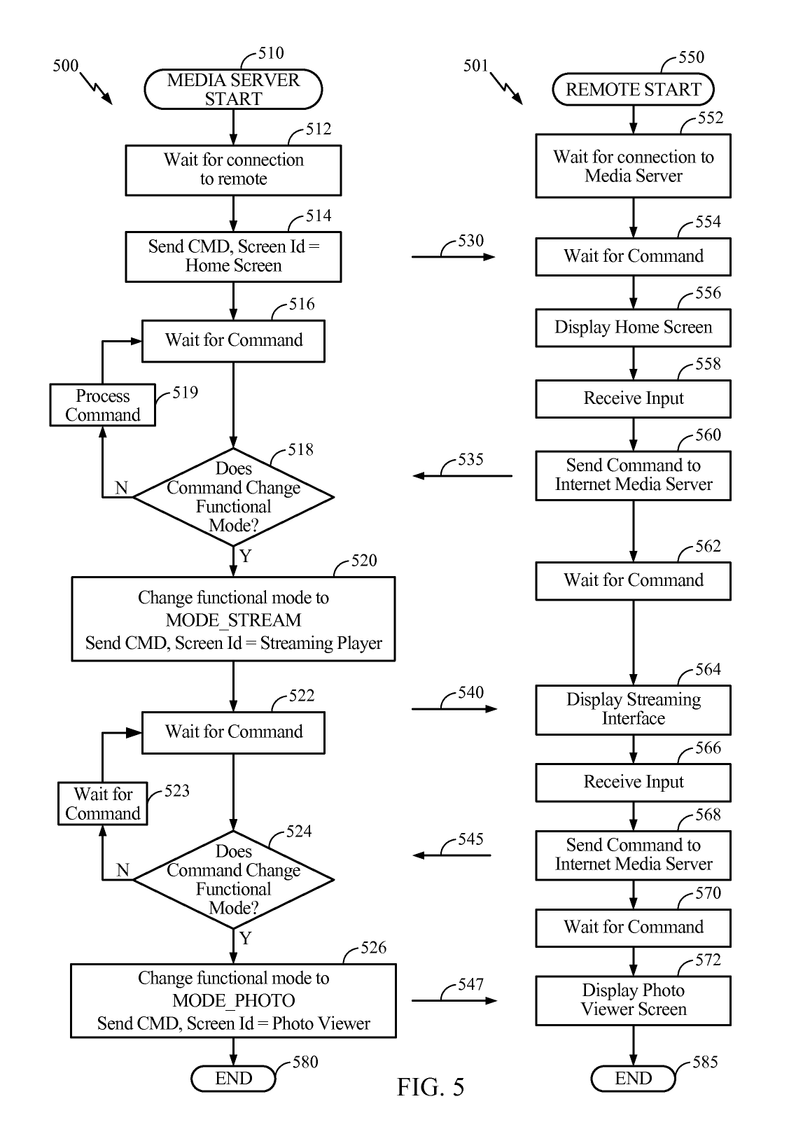

FIG. 5 shows two flowcharts illustrating a process 500 running within an Internet media server device and a process 501 running within one embodiment of a content adaptive remote. Process 500 begins when the Internet media server starts at start block 510 and then moves to block 512 where process 500 waits for a connection to a content adaptive remote to be established. Process 500 then moves to block 514, where a command 530 is sent to a content adaptive remote (running process 501). In the example, the command sent to the content adaptive remote provides a screen id parameter. The screen_id parameter sent by block 514 identifies a “home” screen to the content adaptive remote running process 501. Process 500 then moves to block 516 where it waits for a command from the content adaptive remote running process 501.

Process 501 starts when a content adaptive remote starts at start block 550. Process 500 then moves to block 552, where it waits for a connection to an Internet media server, such as the Internet media server running process 500. Process 501 then moves to block 554 where it waits for a command from the Internet media server. For example, process 501 may wait for the remote command 530 sent by block 514 of process 500. Once the command 530 is received, process 501 may move to block 556, and display a user interface on the content adaptive remote touch screen display. In the illustrated example, the command indicates that process 501 should display a “home” screen. Accordingly, process 501 displays a home screen in processing block 556. Process 501 then moves to block 558, where the process waits to receive input from the home screen displayed in block 556. After input is received, process 501 moves to block 560, where a device command 535 is sent to the Internet media server device running process 500. In some cases, the command 535 received by processing block 558 may cause the Internet media server to enter a new functional mode.

Returning to the description of process 500, when the device command 535 is received by the Internet media server device running process 500, it moves from block 516 to decision block 518. In block 518, the command is examined to determine whether the command should transition the Internet media server device running process 500 into a different functional mode. This decision can be made in several ways depending on the implementation. For example, in one implementation, commands may be structured into different groups. Table 1 below represents one possible implementation of a device command structure.

TABLE 1

| | Does command | |
|---|---|---|
| | change | |
| | functional | New functional |
| Command | mode? | mode |
| STREAM_PLAY | No | N/A |
| STREAM_STOP | No | N/A |
| STREAM_PAUSE | No | N/A |
| MODE_CHANGE_STREAM | Yes | MODE_STREAM |
| MODE_CHANGE_PHOTO | Yes | MODE_PHOTO |
| MODE_CHANGE_GAMING | Yes | MODE_GAMING |
| MODE_CHANGE_HOME | Yes | MODE_HOME |
| MODE_CHANGE_BROWSE | Yes | MODE_BROWSE |
| BROWSE_CLICK | No | N/A |
| BROWSE_RELOAD | No | N/A |
| BROWSE_CANCEL | No | N/A |
| PHOTO_ENLARGE | No | N/A |
| PHOTO_NEXT | No | N/A |
| PHOTO_PREV | No | N/A |
| PHOTO_START_SLIDESHOW | No | N/A |
| GAME_MOVE_LEFT | No | N/A |
| GAME_MOVE_RIGHT | No | N/A |
| GAME_FIRE_WEAPONS | No | N/A |

Table 1 illustrates several commands, and an indication of whether the command will result in a change to the functional mode of an Internet multimedia server device. As can be seen from the table, the commands prefixed with “MODE_CHANGE”, including “MODE_CHANGE_HOME”, “MODE_CHANGE_STREAM”, “MODE_CHANGE_PHOTO”, “MODE_CHANGE_BROWSE,” and “MODE_CHANGE_GAMING” may change the functional mode of an Internet multimedia server device in the illustrated implementation. The other commands do not result in a functional mode change. Some of these commands may be commands that operate within a particular functional mode of a multi-function device such as an Internet multimedia server device. For example, the commands prefixed with “PHOTO” may operate the photo viewing functions of a multi-function device. These commands may only be applicable when the device is in the MODE_PHOTO functional mode. After each of these commands is executed by the device, the functional mode of the device may remain in the “MODE_PHOTO” mode. A device may consult a table such as table 1 when determining whether a received command will result in a change of a functional mode.

If the command does not transition the Internet media server into a different functional mode, process 500 moves to block 519, where the command is processed. Process 500 then returns to block 516 and waits for another command. If the command does transition the Internet media server to a different functional mode, process 500 moves from block 518 to block 520, where a command 540 is sent to the content adaptive remote running process 501. This new command may identify a new user interface to be presented on the content adaptive remote running process 501. In the illustrated process flow, the command 540 sent to the content adaptive remote identifies a streaming user interface, corresponding to the new functional mode of the Internet media server running process 500 that became active in processing block 520.

Returning to the description of process flow 501, the command 540 is received at block 562 of process 501, and then process 501 moves to block 564, where the streaming interface corresponding to the command specified in command 540 is displayed. Process 501 then moves to block 566, where input from the new user interface is received. Input on the streaming interface is translated into a device command 545 for the Internet media server device running process 500. A command 545 is sent from block 568. Process 501 then moves to block 570 where it waits for another command from the Internet media server device running process 500.

Returning again to process 500, the command 545 is received by block 522. Process 500 then moves to decision block 524 where it evaluates whether the command 545 should transition the Internet media server running process 500 into a different functional mode. If the command does not transition the Internet media server into a different functional mode, process 500 moves to processing block 523 where the command is processed. Process 500 then moves back to block 522 where it waits for another command from the content adaptive remote running process 501. If the command does transition the Internet media server running process 500 into a different functional mode, process 500 moves to block 526, where another command 547 is sent to the content adaptive remote running process 501. This command may identify another user interface to be displayed, for example, the user interface of a photo viewing application. For purposes of the illustrated flowchart of FIG. 5, process 500 then moves to end state 580. In actual implementations, one would understand that process 500 may continue processing and sending commands to an adaptive remote control until some termination condition is reached, for example, either the connection with the remote control is disconnected, or a power off event occurs. For brevity, these examples are not illustrated.

Returning briefly to process 501, when command 547 sent by processing block 526 of process 500 is received by the content adaptive remote running process 501, process 501 may move to block 572, where the photo viewing application control screen is displayed on the content adaptive remote. Process 501 then moves to end block 585. One skilled in the art would understand that a process 501 implemented in a real embodiment of the apparatus disclosed would likely continue processing and sending commands to Internet media server device running process 500 as well as receiving and processing commands received via its touch screen display. However, for brevity process 501 is illustrated ending after the photo viewing control screen is displayed.

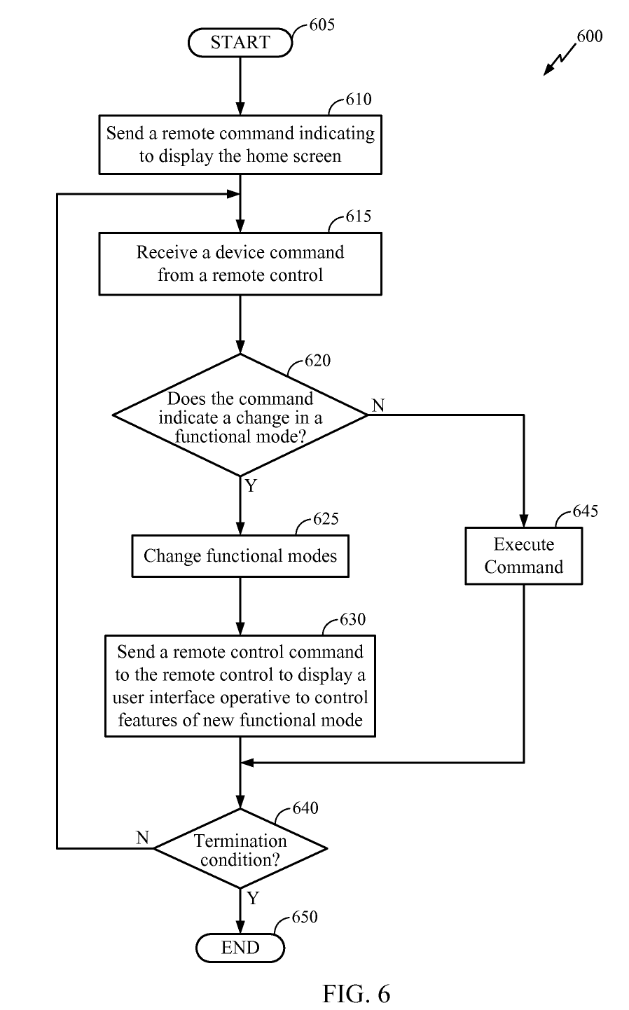

FIG. 6 shows a flowchart illustrating a process 600 that may run within one implementation of an Internet media server device. Process 600 may be implemented by instructions included in the master control module 44, illustrated as part of device 150 in FIG. 4. Alternatively, process 600 may be implemented by instructions included in a combination of modules illustrated in FIG. 6, for example, the master control module 455, streaming control module 440, photo viewing control module 450, remote command sending module 410, and device command receiving module 420.

Process 600 begins at start block 605 and then moves to block 610, where a remote command is sent indicating the remote control should display a “home” screen. Process 600 then moves to block 615, where the process 600 waits to receive a device command from the remote control. After a device command is received from the remote control, process 600 then moves to decision block 620, where the process 600 evaluates whether the command should transition the Internet multimedia server running process 600 into a different functional mode. If the command does not result in a change of functional modes, process 600 moves to block 645, where the command is executed. For example, the command may be a request to perform a function specific to a particular functional mode. If the current functional mode was streaming media for example, a command may be executed to stop, play or fast forward the streaming media file. Process 600 then moves to decision block 640, which evaluates whether a termination condition has been reached. If a termination condition has been reached, process 600 moves to end block 650. Otherwise, decision block 640 moves process 600 back to block 615 where it waits for another device command from the remote control to be received.

Returning to decision block 620, if the command sent by the remote control does indicate a change in a functional mode, process 600 moves to block 625, where the functional mode of the Internet multimedia server device is changed to the functional mode indicated by the command. Process 600 then moves to block 630, where a remote control command is sent to the remote control, indicating the remote control should display a user interface operative to control features of the new functional mode. In some embodiments, the remote control command indicates, via an identifier, a screen that should now be displayed on the touch screen display of the remote control. Process 600 then moves to decision block 640, which as described earlier evaluates whether a termination condition has been reached. Example termination conditions may include a power down event or disconnection from the remote control. If a termination condition has been reached, process 600 moves to end block 650. Otherwise, process 600 returns to block 615 and process 600 repeats from that point.

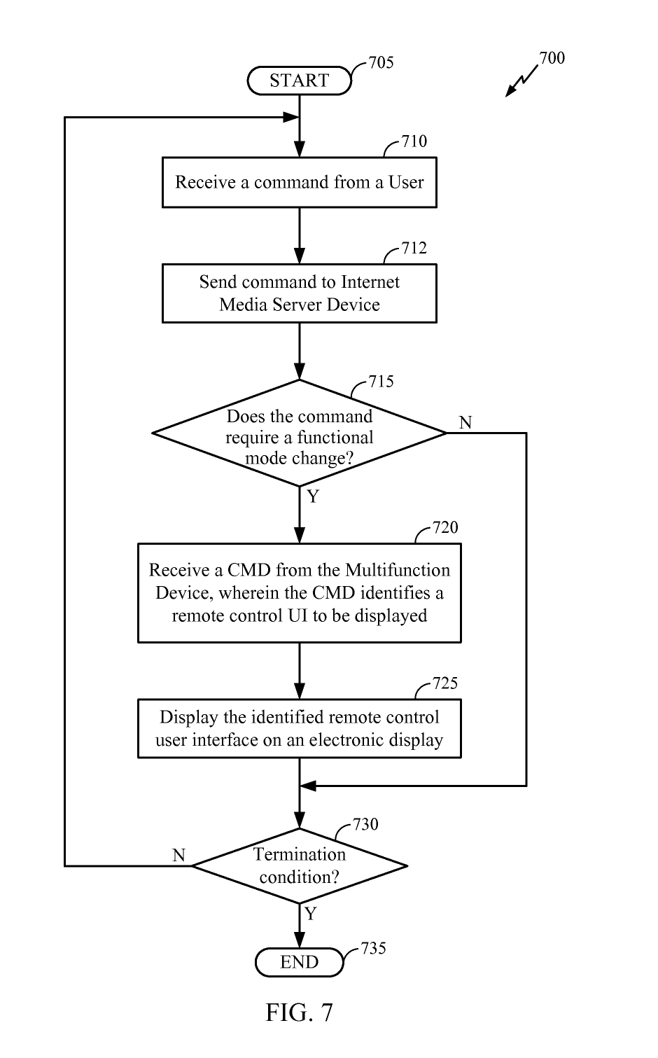

FIG. 7 shows a flowchart illustrating a process 700 that may run within one embodiment of a content adaptive remote control. Process 700 may be implemented by instructions included in the control module 370 illustrated as part of device 100 in FIG. 3. Alternatively, process 700 may be implemented by instructions included in a combination of modules illustrated in FIG. 3, for example, the control module 370, display module 355, remote command receiving module 340, and device command sending module 335.

Process 700 begins at start block 705 and then moves to block 710, where a command is received from a user. Process 700 then moves to block 712, where a command corresponding to the command received from the user in block 710 is sent to an Internet media server device. Process 700 then moves to decision block 715, where the remote control determines whether the command will result in a functional mode change to the Internet media server. If the command does not result in a functional mode change, process 700 moves to decision block 730. If the command will change the functional mode of the Internet media server device, process 700 moves to block 720 where a command is received from the Internet media server device. The command may identify a remote control user interface to be displayed. Process 700 then moves to block 725, where the content adaptive remote displays the identified remote control user interface on an electronic display. Process 700 then moves to decision block 730 where possible termination conditions are checked for. For example, process 700 may terminate if a connection between the content adaptive remote control and an Internet media server is lost. This could occur for example if the Internet media server has been powered down. If a termination condition has not occurred, process 700 moves to block 710, and process 700 repeats. If a termination condition has occurred, process 700 moves to end block 735.

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole. For example, a portion of a collection of pixels may refer to a sub-collection of those pixels.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A method of displaying a user interface on a remote control, the method comprising:
sending a first command to a multifunction device, wherein the first command results in the device leaving a first functional mode and entering a second functional mode;
receiving a second command from the multifunction device, wherein the second command identifies a first remote control user interface to be displayed, the first remote control user interface operative to control features of the multifunction device unique to the second functional mode; and
displaying the first remote control user interface on an electronic display.

2. The method of claim 1, further comprising sending a third command to the multifunction device in response to an input from the first remote control user interface.

3. The method of claim 1, wherein data enabling the display of the first remote control user interface is stored in a memory of the remote control before the second command identifying the first remote control user interface is received by the remote control.

4. The method of claim 2, wherein the input is a touch gesture.

5. The method of claim 1, wherein the first remote control user interface comprises a virtual keyboard.

6. The method of claim 1, wherein the first remote control user interface allows gesture input.

7. A remote control apparatus, comprising:
an electronic display;
a device command sending module configured to send a first command to a multifunction device, wherein the first command results in the multifunction device entering a first functional mode;
a remote command receiving module, configured to receive a second command from the multifunction device, wherein the second command identifies a first remote control user interface to be displayed, the first remote control user interface operative to control features of the device unique to the first functional mode; and
a display module, configured to display the first remote control user interface on the electronic display.

8. The remote control apparatus of claim 7, wherein the command sending module is configured to send the first command by using a radio transmitter, a Bluetooth compatible transmitter, or an infrared compatible transmitter.

9. The remote control apparatus of claim 7, wherein the remote control apparatus is configured to store a plurality of user interfaces that can be displayed on the display screen.

10. The remote control apparatus of claim 7, wherein the electronic display is a touch-screen display.

11. The remote control apparatus of claim 10, wherein the apparatus is a wireless telephone.

12. The remote control apparatus of claim 10, wherein the second command identifies the first remote control user interface by specifying an identifier stored in a memory of the remote control apparatus.

13. A remote control apparatus, comprising:
means for sending a first command to a multifunction device, wherein the first command results in the device leaving a first functional mode and entering a second functional mode;
means for receiving a second command from the multifunction device, wherein the second command identifies a first remote control user interface to be displayed, the first remote control user interface operative to control features of the multifunction device unique to the second functional mode; and
means for displaying the first remote control user interface on an electronic display.

14. The remote control apparatus of claim 13, wherein the means for sending a first command to the multifunction device is processor instructions in a device command sending module.

15. The remote control apparatus of claim 13, wherein the means for receiving a second command from the multifunction device is processor instructions in a remote command receiving module.

16. The remote control apparatus of claim 13, wherein the means for sending a first command to a multifunction device sends the first command by using a radio transmitter, a Bluetooth compatible transmitter, or an infrared compatible transmitter.

17. The remote control apparatus of claim 13, further comprising means for storing a plurality of user interfaces that can be displayed by the means for displaying.

18. The remote control apparatus of claim 13, wherein the means for displaying a first remote control user interface includes a touch-screen display.

19. The remote control apparatus of claim 13, wherein the apparatus is a wireless telephone.

20. The remote control apparatus of claim 13, wherein the second command identifies the first remote control user interface by specifying an identifier stored in a memory of the remote control apparatus.

21. A non-transitory, computer readable storage medium having instructions stored thereon that cause a processing circuit to perform a method comprising:
sending a first command to a multifunction device, wherein the first command results in the device leaving a first functional mode and entering a second functional mode;
receiving a second command from the multifunction device, wherein the second command identifies a first remote control user interface to be displayed, the first remote control user interface operative to control features of the multifunction device unique to the second functional mode; and
displaying the first remote control user interface on an electronic display.

22. The computer readable storage medium of claim 21, wherein the method performed by the processing circuit further comprises sending a third command to the multifunction device in response to an input from the first remote control user interface.

23. The computer readable storage medium of claim 21, wherein data enabling the display of the first remote control user interface is stored in a memory of the remote control before the second command identifying the first remote control user interface is received by the remote control.

24. The computer readable storage medium of claim 22, wherein the input is a touch gesture.

25. The computer readable storage medium of claim 21, wherein the first remote control user interface comprises a virtual keyboard.

26. The computer readable storage medium of claim 21, wherein the first remote control user interface allows gesture input.

27. A method in a multifunction device of controlling a user interface on a remote control, comprising:
receiving a first device command from the remote control, wherein the first device command results in the device leaving a first functional mode and entering a second functional mode; and
sending a first remote control command to the remote control, wherein the first remote control command identifies a first remote control user interface to be displayed, the first remote control user interface operative to control features of the device unique to the second functional mode.

28. The method of claim 27, wherein the first remote control command identifies a first remote control user interface by including an identifier corresponding to the first remote control user interface.

29. The method of claim 27, further comprising:
receiving a second device command from the remote control, wherein the second device command results in the device leaving the second functional mode and entering a third functional mode; and
sending a second remote control command to the remote control, wherein the second remote control command identifies a second remote control user interface to be displayed, the second remote control user interface operative to control features of the device unique to the third functional mode.

30. The method of claim 27, wherein the first remote control command is sent over a Bluetooth connection or a WIFI network.

31. The method of claim 27, wherein the first remote control command is sent over the Internet.

32. A multifunction device, comprising:
a device command receiving module, configured to receive a first device command from a remote control, wherein the first device command results in the device leaving a first functional mode and entering a second functional mode; and
a remote command sending module, configured to send a first remote control command to the remote control, wherein the first remote control command identifies a first remote control user interface to be displayed, the first remote control user interface operative to control features of the device unique to the second functional mode.

33. The multifunction device of claim 32, wherein the first remote control command identifies a first remote control user interface by including an identifier corresponding to the first remote control user interface.

34. The multifunction device of claim 32,
wherein the device command receiving module is further configured to receive a second device command from the remote control, wherein the second device command results in the device leaving the second functional mode and entering a third functional mode, and
wherein the remote command sending module is further configured to send a second remote control command to the remote control, wherein the second remote control command identifies a second remote control user interface to be displayed, the second remote control user interface operative to control features of the device unique to the third functional mode.

35. A multifunction device, comprising:
means for receiving a first device command from a remote control, wherein the first device command results in the device leaving a first functional mode and entering a second functional mode; and
means for sending a first remote control command to the remote control, wherein the first remote control command identifies a first remote control user interface to be displayed, the first remote control user interface operative to control features of the device unique to the second functional mode.

36. The multifunction device of claim 35, wherein the means for receiving a first device command is processor instructions in a device command receiving module.

37. The multifunction device of claim 35, wherein the means for sending a first remote control command is processor instructions in a remote command sending module.

38. The multifunction device of claim 35, wherein the first remote control command identifies a first remote control user interface by including an identifier corresponding to the first remote control user interface.

39. The multifunction device of claim 35, further comprising:
means for receiving a second device command from the remote control, wherein the second device command results in the device leaving the second functional mode and entering a third functional mode, and
means for sending a second remote control command to the remote control, wherein the second remote control command identifies a second remote control user interface to be displayed, the second remote control user interface operative to control features of the device unique to the third functional mode.

40. A non-transitory, computer readable storage medium having instructions stored thereon that cause a processing circuit to perform a method comprising:
receiving a first device command from a remote control, wherein the first device command results in the device leaving a first functional mode and entering a second functional mode; and
sending a first remote control command to the remote control, wherein the first remote control command identifies a first remote control user interface to be displayed, the first remote control user interface operative to control features of the device unique to the second functional mode.

41. The computer readable storage medium of claim 40, wherein the first remote control command identifies a first remote control user interface by including an identifier corresponding to the first remote control user interface.

42. The computer readable storage medium of claim 40, wherein the method performed by the processing circuit further comprises:
receiving a second device command from the remote control, wherein the second device command results in the device leaving the second functional mode and entering a third functional mode; and
sending a second remote control command to the remote control, wherein the second remote control command identifies a second remote control user interface to be displayed, the second remote control user interface operative to control features of the device unique to the third functional mode.

43. The computer readable storage medium of claim 40, wherein the first remote control command is sent over a Bluetooth connection or a WIFI network.

44. The computer readable storage medium of claim 40, wherein the first remote control command is sent over the Internet.
